(19) United States
(12) Patent Application Publication
(10) Pub. No.: US 2004/0122891 A1
(43) Pub. Date: Jun. 24, 2004

(54) Proactively notify users of solutions

(76) Inventors: Paul A. Meyers, Granite Bay, CA (US); Richard Santos, Roseville, CA (US); Jeffrey Siegle, Campbell, CA (US)

Correspondence Address: HEWLETT-PACKARD COMPANY, Intellectual Property Administration, P.O. Box 272400, Fort Collins, CO, 80527-2400, US

(21) Appl. No.: 10/324,586

(22) Filed: Dec. 19, 2002

(51) Int. Cl. G06F 15/16; G06F 17/00

(52) U.S. Cl. 709/203; 709/206; 707/104.1

(57) ABSTRACT

In an embodiment, the present invention is directed to notifying a user of web content elements maintained by an information site. The notification may occur by processing web content queries from a user. First web content elements communicated in response to the queries and selected by the user may be associated with the user via a user profile. The first web content elements may be compared against second web content elements to identify related web content elements. The user may then be notified of the related web content elements.

### FIELD OF THE INVENTION

The present invention is related, in general, to systems and methods for communicating information to users and, more particularly, to systems and methods for notifying users of content.

### DESCRIPTION OF RELATED ART

To facilitate customer service operations, many organizations provide content related to their products via an Internet site to permit users to retrieve pertinent information on an automated basis. The content may be organized in a number of ways. A site index may be provided or users may navigate through a series of categories, subjects, links, and/or the like. Such an organizational structure for content is clearly better than a purely random structure. However, the organizational structure is somewhat arbitrary in that the organization structure depends on the subjective decisions of the entity responsible for the web server as opposed to the actual needs of the users.

Alternatively, users may post content on the Internet site such as questions to other uses and responses to such questions. For example, a particular user may discover or create a technical solution (e.g., a software patch, a configuration setting, and/or the like) to a problem that is common to a relatively large number of users. The user may post the technical solution to share the discovery with other users. Additionally, such postings may be retained in a discussion thread format. For example, subsequent users may post updates related to the previously posted technical solution thereby continuing the thread of discussion related to the associated problem.

Moreover, many sites permit users to access content according to a number of available options in an effort to provide as much information as possible. However, the provision of a large amount of information actually becomes problematic. Specifically, even if a web server maintains relevant information, a user may be unable to locate the information among the numerous web pages and postings. To address this problem, many web servers provide keyword searching capabilities to reduce the amount of time a user must spend sorting through the information maintained by the web server. Although keyword searching is advantageous as compared to pure manual searching, keyword searching requires significant effort on the part of users. For example, keyword searches require the user to understand the terms of the subject matter. Also, many keyword searches may return a very large number of results which must be manually reviewed for relevance. Alternatively, an overly narrowed keyword search may inadvertently exclude the information of interest to a particular user. Moreover, keyword searches do not provide a mechanism to inform the user of information that is relevant to the search that is added at a later time.

### SUMMARY OF THE INVENTION

In an embodiment, the present invention is directed to notifying a user of web content elements maintained by an information site. The notification may occur by processing web content queries from a user. First web content elements communicated in response to the queries and selected by the user may be associated with the user via a user profile. The first web content elements may be compared against second web content elements to identify related web content elements. The user may then be notified of the related web content elements.

### BRIEF DESCRIPTION OF THE DRAWINGS

FIG. 1 depicts a system for notifying users of content according to embodiments of the present invention.

FIG. 2 depicts a flowchart for updating a user profile according to embodiments of the present invention.

FIG. 3 depicts a flowchart for notifying a user of content utilizing a user profile according to embodiments of the present invention.

FIG. 4 depicts a screen which may be presented to the user when the user initially accesses an information site via the user's browser according to embodiments of the present invention.

FIG. 5 depicts an initial content screen that may be presented to a user according to embodiments of the present invention.

FIG. 6 depicts a content screen that includes a plurality of graphical controls that may be presented to a user according to embodiments of the present invention.

FIG. 7 depicts an individualized initial content screen that may be presented to a user according to embodiments of the present invention.

FIG. 8 depicts a computer system that may be utilized to implement embodiments of the present invention.

### DETAILED DESCRIPTION

Embodiments of the present invention address the difficulties associated with searching through a large number of documents or content from an information site to identify documents or content that is relevant to the user. In embodiments of the present invention, a suitable user interface is utilized to permit a user to search an information site. For example, a web server may provide a user interface via a hypertext markup language (HTML) documents or the like. One of the HTML documents may request identification information from the user. The identification information may be utilized to update or access a user profile. The user profile may store identification of content that the user has previously identified as being relevant. In embodiments of the present invention, a profiling process may compare other content (e.g., newly added content) to the content identified in the user profile. If the other content is related to previously identified content, a notification process may notify the user of the additional content (e.g., sending an e-mail or other Internet messaging service to the user).

FIG. 1 depicts a block diagram of system 100 that may profile content associated with an information site according to embodiments of the present invention. System 100 comprises document database 101. Document database 101 may comprise a plurality of files to store the actual content. Moreover, document database 101 may comprise a plurality of document records to manage the content. The document records may include a document identifier and a pointer to the particular file of the respective content. The document records may further include keyword fields associated with the respective content. Additionally, the document records may include a boolean field that indicates whether the content is a “solution document” as will be described in greater detail herein below.

System 100 may further comprise user profile database 102. User profile database 102 may be utilized to manage the presentation of content for a plurality of users according to embodiments of the present invention. User profile database 102 may comprise a plurality of user profiles 106 to identify content previously identified by users. User profile 106 may comprise a user ID field to identify users when the users access the information site. Additionally, user profile 106 may comprises a plurality of document identifiers that were previously selected by the respective user in some manner. Each document may be associated with a weighting parameter. The weighting parameter may be utilized to measure the relevance of the document to the user. Additionally, each document may be associated with a temporal parameter that retains the date when the user selected the respective document. Documents may be removed from user profile 106 according to the temporal information.

System 100 may comprise user interface process 107 that may present content to users in accordance with embodiments of the present invention. User interface 107 may be implemented, for example, as part of a web server. User interface 107 may comprise profile process 103 that includes comparison algorithm 104 and notification process 105. Comparison algorithm 104 may compare content when content is added to document database 101 to determine whether the added content is related to documents previously identified by users. Comparison algorithm 104 may, for example, perform a keyword comparison to determine whether the added content is related to previously identified content. If comparison algorithm 104 determines that the added content is related, notification algorithm 105 may notify users of the related content. For example, notification algorithm 105 may include a digest or summary of the related content in an initial web page when a user accesses the information site. Additionally and/or alternatively, notification algorithm 105 may e-mail notification of the related content to users. Notification algorithm 105 may utilize other notification protocols such as Internet instant messaging services.

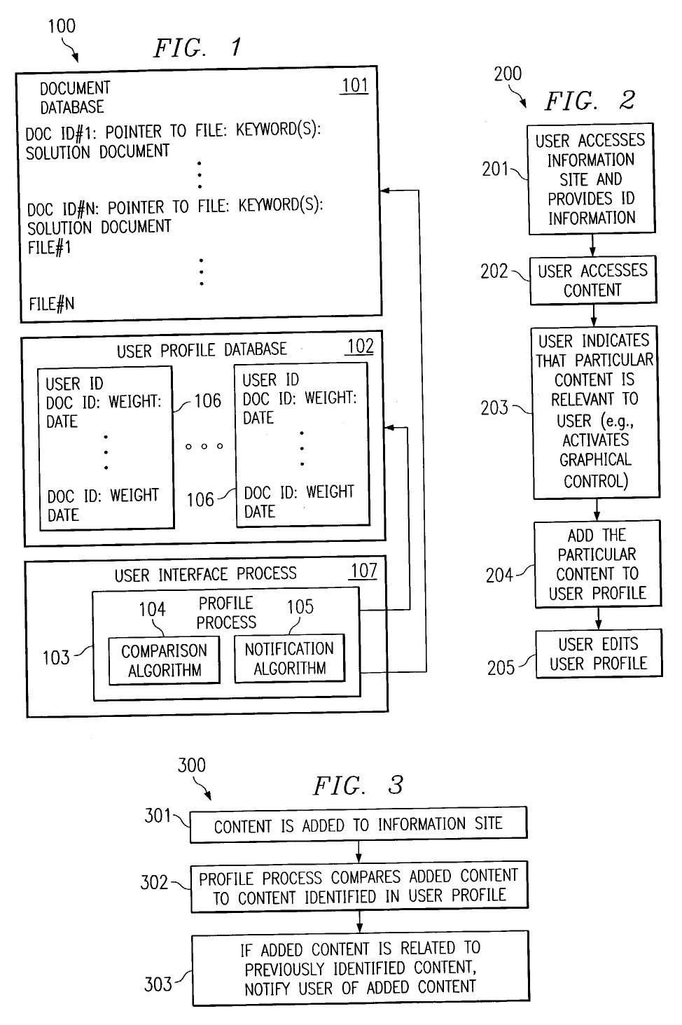

FIG. 2 depicts flowchart 200 for updating user profile 106 according to embodiments of the present invention. In step 201, a user accesses an information site and provides identification information. The access may be initiated when the user sends a hypertext transfer protocol (HTTP) request to a web server associated with a particular domain name or suitable Internet Protocol address via a browser application. The web server may then communicate an HTTP response to the browser application. The HTTP response may include an HTML file that includes an appropriate graphical control (e.g., a text box) to request a user ID. After the user keys the user ID in the appropriate text control, the browser application may communicate another HTTP request to the web server that includes the user ID. The web server may track further communication by writing a suitable “cookie” (a text file managed by the browser application and automatically communicated to the web server) on the user's system.

In step 202, the user accesses content on the information site in any appropriate manner. For example, the user may browse various categories of documents, frequently asked questions (FAQs), discussion threads, and/or the like. The user may perform keyword or other searches of any of the content maintained on the information site.

In step 203, the user indicates that particular content is relevant to the user. For example, the web server may create HTML pages that include a specific graphical control (e.g., a “button”) that allows the user to indicate that the particular content associated with the respective HTML page is relevant to the user. Additionally or alternatively, the relevance may be inferred from other user actions. For example, a graphical control may be provided to permit the user to download or otherwise receive a copy of the content in another format (e.g., a “PDF” file). If the user selects this option, it may be inferred that the user intends to inspect the content and, hence, the content is relevant to the user. If both methods are used to determine the relevance, it may be advantageous to provide a lesser weight to the relevance of a document identified through inference.

In step 204, the particular content is added to user profile 106 by, for example, writing its document ID into user profile 106. Other information may be added to user profile such as the date of the selection of the content. Moreover, a weighting factor may be added to user profile 106. If the user directly indicates that the selected content is relevant, a higher weighting factor may be utilized in comparison to a weighting factor utilized for content that is downloaded by the user.

In step 205, the user may be permitted to edit user profile 106. For example, the user may have previously indicated that a particular document was relevant due the user's prior job responsibilities. However, the user's responsibilities may have changed and the user may no longer have any interest in reviewing content related to the previously selected document. Accordingly, the user may be permitted to delete the particular entry from user profile 106.

FIG. 3 depicts flowchart 300 for notifying a user of content utilizing user profile 106 according to embodiments of the present invention. In step 301, content may be added to the information site. In step 302, comparison algorithm 104 may compare the added content to content previously selected or identified in user profile 106. The comparison may be performed by utilizing, for example, keyword analysis. If sufficient similarity exists, the user is notified of the added content (step 303). Alternatively, if a moderate degree of similarity exists to a previously identified document and a sufficiently high weighting factor is associated with the identified document, the user may be notified of the added content even though the added content does not exactly match prior selections. In an embodiment of the present invention, an e-mail may be sent to the user which contains a summary or digest of the added material. The e-mail may be sent on a daily, weekly, or other basis to include all of the related content added within the appropriate time frame. Alternatively or additionally, the user may be notified of added content when the user subsequently accesses the information site.

Although the present invention has been described as processing new content or added documents, it shall be appreciated that the present invention is not so limited. Embodiments of the present invention may utilize user profile 106 to analyze content that exists concurrently with the identified content for the purpose of bringing the user's attention to the other content.

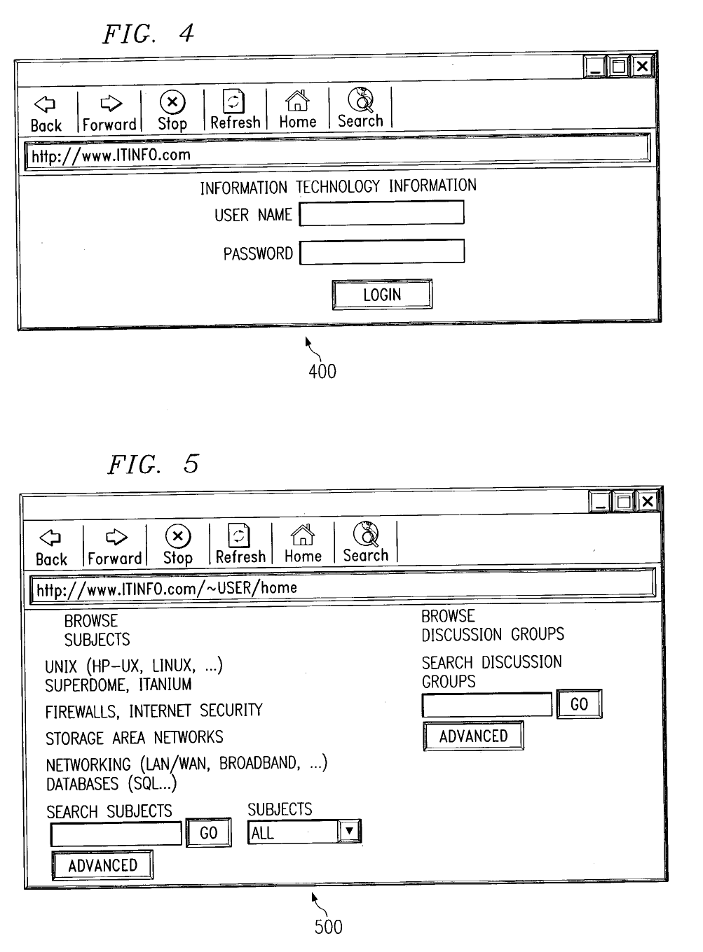

FIGS. 4-7 depict a series of screens that may be viewed by a user operating a browser application in association with embodiments of the present invention. FIG. 4 depicts screen 400 which may be presented to the user when the user initially accesses an information site via the user's browser. Screen 400 comprises a text control box to receive the user ID. After the user supplies the user ID and/or a password, the user is presented with initial content screen 500 as shown in FIG. 5. Screen 500 may comprise several subject categories that permit the user to browse various subjects of interest. Similarly, screen 500 comprises a link to permit the user to browse a discussion group. The user may also perform searches of either of the categories of subjects or the discussion groups.

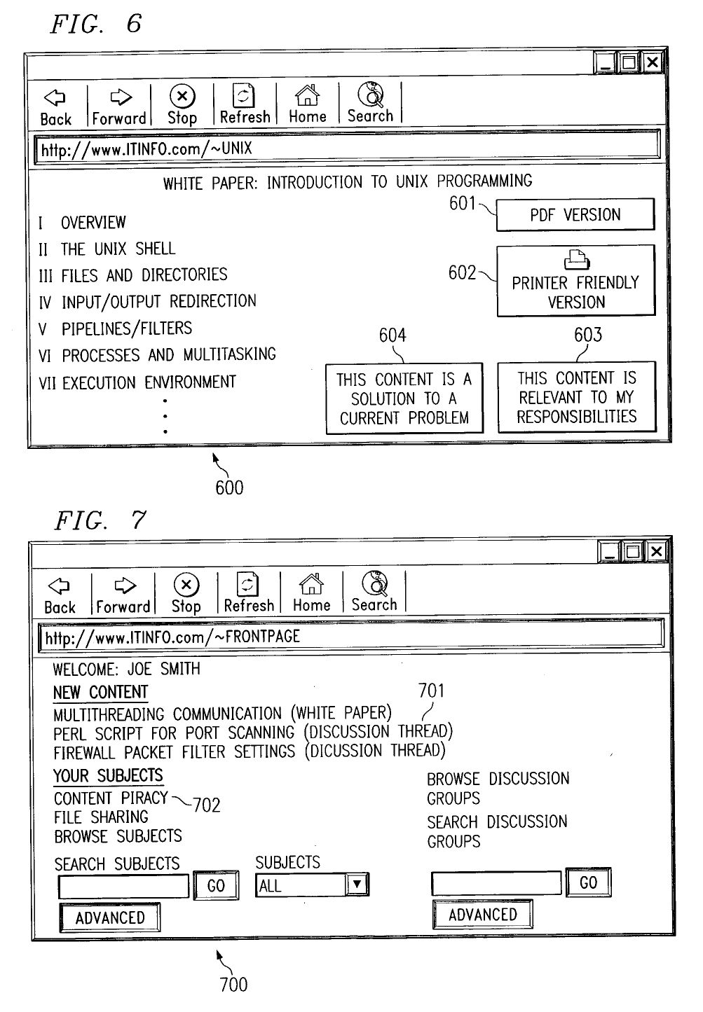

After navigating or searching content associated with the information site, the user may locate content of interest. The content may be presented in content screen 600 as shown in FIG. 6. Content screen 600 may comprise the content (shown as the white paper “INTRODUCTION TO UNIX PROGRAMMING” in this example) or a portion thereof. Content screen 600 may further comprise a number of graphical controls or “buttons” to perform various actions. For example, graphical control 601 may permit the user to download or view a PDF version of the white paper. Graphical control 602 may permit the user to download or view a “printer friendly” version of the white paper. The user may indicate that the content is relevant to the user by selecting graphical control 603. The user may further indicate that the content provides a solution of a current problem by selecting control 604. When the user selects any one of controls 601-604, the document ID of the white paper may be added to user profile 106. In embodiments of the present invention, a highest weighting factor may be utilized if the user selects control 604, a second highest weighting factor may be utilized for selection of control 603, and a lowest weighting factor may be utilized for selection of either control 601 or 602.

When the user subsequently accesses the information site and supplies the user's password, individualized initial content screen 700 may be provided to the user. Screen 700 may comprise listing 701 of content is that is relevant to the user as determined by comparison to prior selections of the user stored in user profile 106. The user may advantageously access content associated with listing 701 by clicking on a respective entry. Also, the presentation of the content may be sorted utilizing a number of factors. Listing 701 may be sorted according to weighting factors associated with the documents identified by the user. Additionally or alternatively, listing 701 may be sorted according to the identification of relevance by other users. For example, if a particular document (that is related to a document selected by a user) has been previously selected by a relatively large number of other users, the particular document may be presented at the top of listing 701. Moreover, the presentation of a particular element of listing 701 may be enhanced (e.g., highlighted) if the content has been identified as a solution by other users. Additionally or alternatively, screen 700 may comprise individualized subject categories 702. Individualized subject categories 702 may be presented if a sufficient number of documents are determined to be related to content previously identified by the user to permit the user to browse the related documents or content in a more convenient manner.

When implemented via executable instructions, various elements of the present invention are in essence the code defining the operations of such various elements. The executable instructions or code may be obtained from a readable medium (e.g., hard drive media, optical media, EPROM, EEPROM, tape media, cartridge media, and/or the like) or communicated via a data signal from a communication medium (e.g., the Internet). In fact, readable media can include any medium that can store or transfer information.

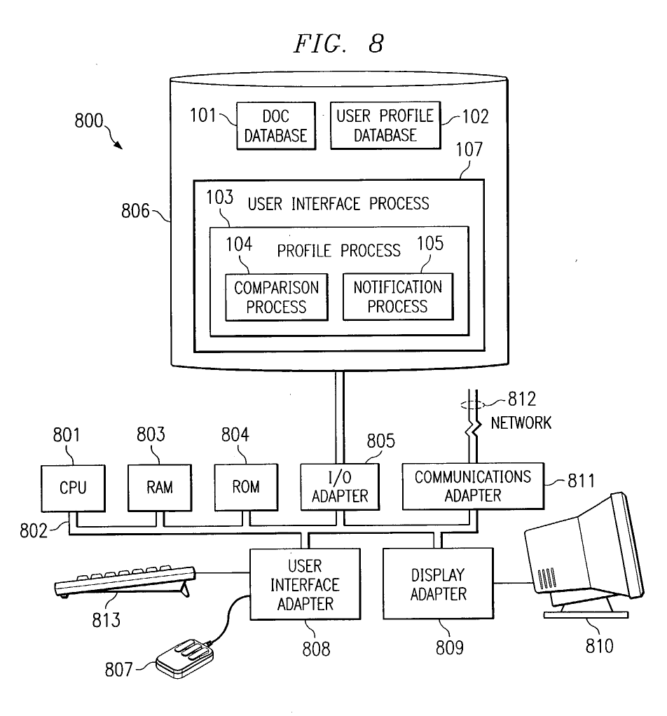

FIG. 8 illustrates computer system 800 adapted according to embodiments of the present invention. Central processing unit (CPU) 801 is coupled to system bus 802. CPU 801 operates under the control of suitable instructions. In embodiments of the present invention, CPU 801 operates, in part, under the control of the instructions or code that implement user interface process 107, profile process 103, comparison algorithm 104, and notification algorithm 105. CPU 801 may be implemented utilizing any general purpose CPU. However, the present invention is not restricted by the architecture of CPU 801 as long as CPU 801 supports the inventive operations as described herein.

Computer system 800 also includes random access memory (RAM) 803, which may be SRAM, DRAM, SDRAM, or the like. Computer system 800 includes ROM 804 which may be PROM, EPROM, EEPROM, or the like. RAM 803 and ROM 804 hold user and system data and programs as is well known in the art. User interface adapter 808 couples user input devices, such as keyboard 813 and pointing device 807, to computer system 800. Display adapter 809 is driven by CPU 801 to control the display on display device 810.

Computer system 800 also includes input/output (I/O) adapter 805, communications adapter 811, user interface adapter 808, and display adapter 809. I/O adapter 805 connects to storage devices 806, such as one or more of hard drive, CD drive, floppy disk drive, tape drive, to computer system 800. Storage devices 806 may be utilized to store the instructions or code that implement user interface process 107, profile process 103, comparison algorithm 104, and notification algorithm 105. Moreover, storage devices 806 may retain the content (document database 101) maintained on the information site. Likewise, storage devices 806 may retain user profile database 102.

Communications adapter 811is adapted to couple computer system 800 to a network 812, which may be one or more of telephone network, local (LAN) and/or wide-area (WAN) network, Ethernet network, and/or Internet network. System 800 may receive and respond to requests to access its managed content utilizing communications adapter 811.

Embodiments of the present invention may provide several advantages over known systems and methods for presenting content to users. Specifically, embodiments of the present invention do not arbitrarily limit the organization of content to subjective decisions of a single party. Instead, the presentation and/or organization content is tailored by the users themselves. Users may update and manage their user profile such that content that is most relevant to the users are presented in a manner that facilitates efficient retrieval of the relevant content.

What is claimed is:

1. A system for notifying a user of web content elements maintained by an information site, comprising:
user interface means for processing web content queries from the user, wherein the user interface means associates first web content elements with the user utilizing a user profile, wherein the first web content elements are communicated in response to the web content queries and selected by the user; and
notifying means for comparing second web content elements to the first web content elements and for notifying the user of ones of the second web content elements that are related to the first web content elements.

2. The system of claim 1 wherein the second web content elements are web content elements that is added to the information site.

3. The system of claim 1 wherein the notifying means includes a listing of the ones of the second web content elements that are related to the first web content elements in a web page presented to the user.

4. The system of claim 1 wherein the notifying means sends an Internet message to the user that includes notification of the ones of the second web content elements that are related to the first web content elements, wherein the Internet message is selected from the list consisting of: an e-mail and an instant message.

5. The system of claim 1 wherein the user interface means associates respective weighting factors with respective ones of the first web content elements identified in the user profile depending on a manner of selection of the ones of the first web content elements.

6. The system of claim 1 wherein the notifying means creates individualized subject categories of the ones of second web content elements that are related to the first web content elements.

7. The system of claim 1 wherein the user interface means removes identification of selected ones of the first web content elements from the user profile according to user input.

8. A method for notifying a user of web content elements maintained by an information site, comprising:
receiving user input that identifies first web content elements as being relevant to the user;
updating a user profile according to the identified first web content elements;
comparing the first web content elements to second web content elements to determine ones of the second web content elements that are related to the first web content elements, wherein the comparing uses the user profile; and
notifying the user of the ones of the second web content elements that are related to the first web content elements.

9. The method of claim 8, wherein said second web content elements are web content elements added to said information site subsequent to identification of said first web content elements by said user.

10. The method of claim 8 further comprising:
creating a web page that includes a listing of the ones of the second web content elements that are related to the first web content elements.

11. The method of claim 8 further comprising:
sending an Internet message to the user that includes a listing of the ones of the second web content elements that are related to the first web content elements, wherein the Internet message is selected from the list consisting of: an e-mail and an instant message.

12. The method of claim 8 further comprising:
associating respective weighting factors with respective ones of the first web content elements identified in the user profile depending on a manner of selection of the ones of the first web content elements.

13. The method of claim 8 further comprising:
creating individualized subject categories of the ones of second web content elements that are related to the first web content elements.

14. The method of claim 8 further comprising:
receiving user input to edit the user profile.

15. A computer readable medium storing a computer program product for notifying a user of web content elements maintained by an information site, comprising:
code for processing web content queries from the user, wherein the code for processing receives user selection of first web content elements that are identified in response to the user queries;
code for associating the first web content elements with the user utilizing a user profile;
code for comparing second web content elements to the first web content elements utilizing the user profile to identify ones of the second web content elements that are related to the first web content elements; and
code for notifying the user of the ones of the second web content elements that are related to the first web content elements.

16. The computer readable medium of claim 15 wherein the code for comparing compares web content elements added to the information site to the first web content elements.

17. The computer readable medium of claim 15 wherein the code for notifying includes a listing of the ones of the second web content elements that are related to the first web content elements in a web page presented to the user.

18. The computer readable medium of claim 15 wherein the code for notifying sends an Internet message to the user that includes notification of the ones of the second web content elements that are related to the first web content elements, wherein the Internet message is selected from the list consisting of: an e-mail and an instant message.

19. The computer readable medium of claim 15 wherein the code for updating associates respective weighting factors with ones of the first web content elements depending on a manner of selection of the ones of the first web content elements.

20. The computer readable medium of claim 15 further comprising:
code for receiving user input to edit the user profile.
